(19) United States
(12) Patent Application Publication
(10) Pub. No.: US 2026/0327382 A1
(43) Pub. Date: Oct. 22, 2026

(54) METHOD OF PRODUCING LIGNIN WITH CONTROLLED STRUCTURAL PROPERTIES USING HETEROCYCLE COMPOUNDS

(71) Applicant: WASHINGTON STATE UNIVERSITY, Pullman, WA (US)

(72) Inventors: Xiao ZHANG, Pullman, WA (US); Aboutaleb AMELI, Pullman, WA (US); Kuan-ting LIN, Pullman, WA (US); Ruoshui MA, Pullman, WA (US); Che-hao YANG, Pullman, WA (US)

(21) Appl. No.: 19/486,232

(22) PCT Filed: May 21, 2024
(86) PCT No.: PCT/US2024/030348

§ 371 Date: Nov. 20, 2025

Related U.S. Application Data
(60) Provisional application No. 63/505,688, filed on Jun. 1, 2023.

(51) Int. Cl. C08H 7/00; C08B 1/00; C08L 23/06; C08L 67/02; C08L 67/04

(52) U.S. Cl. CPC C08H 6/00; C08B 1/003; C08L 23/06; C08L 67/02; C08L 67/04

(57) ABSTRACT

Methods of extracting lignin from a plant biomass are provided. The methods include mixing a solvent with the plant biomass to form a mixture, wherein the solvent is a deep eutectic solvent comprising a heterocyclic compound, heating the mixture for a time period sufficient to release lignin from the plant biomass, and extracting lignin from the mixture after heating. The extracted lignin may be mixed with polymers to form composite materials such as carbon fiber, plastics, thermoset polymers, thermoplastics, resin, adhesives and specialty fibers. The method may also be used to extract cellulose from the plant biomass.

### CROSS REFERENCE TO RELATED APPLICATIONS

This application claims the benefit of U.S. Provisional Patent Application 63/505,688 filed on Jun. 1, 2023, and incorporates said provisional application by reference into this document as if fully set out at this point.

### STATEMENT REGARDING FEDERALLY SPONSORED RESEARCH OR DEVELOPMENT

This invention was made with government support under grant no. 1454575 awarded by National Science Foundation and grant no. 2018-67009-27902 awarded by the United States Department of Agriculture through the National Institute of Food & Agriculture. The government has certain rights in the invention.

### FIELD OF THE INVENTION

The embodiments herein relate to methods of extracting lignin from a plant biomass with controlled structural properties and chemical characteristics. The lignin may be used to produce composite materials such as carbon fiber, plastics, thermoset polymers, thermoplastics, resin, adhesives and specialty fibers.

### BACKGROUND

Lignin comprises one third of the natural biomass resources on Earth. The emerging biomass refinery industry will generate an enormous amount of lignin as a waste in biochemical biomass-to-biofuel conversion processes, an estimated 225 million tons, from converting 750 million tons of biomass feedstock into biofuel. No practical biorefinery lignin valorization process has been demonstrated so far. Given the potential volume of biorefinery lignin, diverting the majority for material production is a particularly appealing approach. Unfortunately, existing technologies cannot produce high performance composites such as carbon fiber with a lignin constituent above 30%. The key to solve this technical challenge is to identify an ideal lignin substrate with higher structural homogeneity and a set of unique structural specifics that can promote a steady interaction with its co-polymers.

Lignin is a polymer constructed mainly of a number of phenylpropane units such as guaiacyl and syringyl p-hydroxyphenyl connected by ether and carbon and carbon linkages. In the last two decades, there is a growing interest in converting renewable plant biomass to chemicals, fuel and materials. Lignin typically represent 15-35% of plant biomass weight. Its structural characteristics and physiochemical properties are drastically different from the other two major plant components, cellulose and hemicellulose. The low bulk price of lignin and the huge sources has made the utilization of lignin for composite material preparation a good proposition. However, there has not yet been any practical method to produce lignin-based material with high lignin content. Normally, lignin-based composites are deconstructed easily after the lignin content in the composite material reaches up to 30 wt. %. Adding lignin significantly damages the mechanical performance of the composite materials, hampering their practical applications.

Lignin is an abundant renewable feedstock and its monomeric constituent, phenylpropane unit indeed provides an ideal structure for material applications. The challenges of direct conversion of lignin macromolecule into materials are due to two main structural properties of lignin macromolecule: 1) Lignin is a polymer with wide molecular weight distributions, and 2) Although phenylpropane is the basic unit, there are different functional groups attached to both the side chain and the aromatic ring to make lignin a heterogeneous molecule with diverse functionality and reactivity.

In addition, the purity of lignin is a beneficial factor in contributing to the final strength properties of the materials. Structural homogeneity is a key to maintain high material performance. To cleave lignin inter-unit bonds selectively while preventing formation of new bonds is crucial to produce ideal lignin substrate for material production. Among the lignin inter-unit linkages, ether-linkages are susceptible to cleave under mild acid/base/oxidative/reductive treating conditions, while carbon-carbon linkages are usually inert unless under very severe treating conditions. However, there exists no technology or strategy that can convert lignin feedstock to a value-added high-lignin-containing material in a practical way. A homogenous lignin structure with a consistent molecular weight and nanoscale dimension will thus promote its applicability to the preparation of high-performance lignin-based composites and polymers. This is an approach that has not yet been successfully demonstrated.

Maximizing the value of lignin is perhaps the most pivotal endeavor toward realizing lignocellulosic biomass renewable fuels and biobased materials. The complex and heterogenous nature of lignin macromolecule has presented a lasting barrier in its utilization. The compact nature of the plant cell wall and intricate interactions among cell wall macromolecules (i.e. cellulose, hemicellulose, lignin) make the clean and high yield extraction of lignin a formidable challenge. Many technical lignin separation methods have been investigated for obtaining proto or native lignin, including mild acid milling processes and cellulase enzymatic hydrolysis (lignin yield: 10% to 40%). All these methods have struggled with achieving a high lignin recovery yield while minimizing lignin structural alteration. In addition, there has been continued debate on whether this technical lignin truly represents the native lignin existing in plants. It has been speculated that native lignin present in wood may have consistent properties, while the significant variations observed in lignin products are introduced during the separation process.

Accordingly, there is a need to identify a lignin separation method that results in a high yield of lignin with controlled structural properties (e.g. molecular weight range, functional group contents, etc.).

### SUMMARY

The embodiments herein generally entail a method to produce lignin in large quantities with high purity and with controlled structured properties and chemical characteristics. The lignin products generated from this method include varieties ranging from native-like lignin all the way to low molecular weight ether free lignin. These lignin products can be applied for preparation of composite materials, including but not limited to thermoset, thermoplastics and carbon fibers.

An aspect of the disclosure provides a method of extracting lignin from a plant biomass, comprising mixing a solvent with the plant biomass to form a mixture, wherein the solvent is a deep eutectic solvent comprising a heterocyclic compound; heating the mixture for a time period sufficient to release lignin from the plant biomass; and extracting lignin from the mixture after heating. In some embodiments, the heterocyclic compound is a nitrogen heterocyclic compound. In some embodiments, the nitrogen heterocyclic compound is selected from, but not limited to, pyridine, pyrrole, and pyrazole. In some embodiments, the solvent further comprises one or more of lactic acid, choline chloride, urea, and aniline. In some embodiments, the plant biomass is a grain crop, wood, or grass. In some embodiments, the mixture is heated at a temperature from 50° C. to 150° C. In some embodiments, the time period ranges from 0.1 hour to 24 hours. In some embodiments, an extraction yield of the lignin is at least 30%. In some embodiments, the method has a lignin extraction selectivity of at least 0.35. In some embodiments, a purity of the extracted lignin is at least 90%. In some embodiments, the extracted lignin has a polydispersity index less than 1.9.

Another aspect of the disclosure provides a lignin composition prepared by a method as described herein.

Another aspect of the disclosure provides a method of preparing a composite material, comprising mixing lignin obtained according to a method as described herein with a polymer to form the composite material. In some embodiments, the polymer is selected from the group consisting of polyacrylonitrile (PAN), polylactic acid (PLA), polyethylene terephthalate glycol (PETG), and high-density polyethylene (HDPE). In some embodiments, the method further comprises mixing a crosslinking agent with the lignin and polymer to form the composite material. In some embodiments, the crosslinking agent is a siloxane compound. In some embodiments, the method further comprises mixing cellulose nanofibers with the lignin and polymer to form the composite material. In some embodiments, the mixing is performed by extrusion, wet spinning, melting spinning, or casting. In some embodiments, a ratio of lignin to polymer is from 1:9 to 9:1.

Another aspect of the disclosure provides a method of extracting cellulose from a plant biomass, comprising mixing a solvent with the plant biomass to form a mixture, wherein the solvent is a deep eutectic solvent comprising a heterocyclic compound, heating the mixture for a time period sufficient to release cellulose from the plant biomass, and extracting cellulose from the mixture after heating.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

### BRIEF DESCRIPTION OF THE FIGURES

FIG. 1A-B. Molecular interactions of La-Py DES (A) 1H NMR of pyrazole (top), lactic acid (middle), and La-Py DES (bottom). (B) Schematic hydrogen bonding interactions proposed for La-Py DES.

FIG. 2A-C. Optimized geometries for lignin-phenolics in La-Py DES A) Guaiacol, B) Catechol, and C) Isocugenol. The hydrogen bonds are indicated by dotted lines and given with corresponding atom numbers.

FIG. 3. Chemical composition of solid residue, soluble fraction, and lignin extraction yield after La-Py DES treatments of wheat straw.

FIG. 4. Pyrazole preventing lignin condensation.

FIG. 5A-C. Correlation between treatment parameters and lignin properties: A) ether linkage content, B) phenolic hydroxyl, and C) molecular weight (Laₘ-Pyₙ means molar ratio of La:Py in DES is m:n. La1Py1_90 and the like indicate the treatment happened at 90° C. All treatments lasted for 9 h).

FIG. 6. Aspen Plus model flow sheet of lignin extraction from wheat straw by La-Py DES.

FIG. 7. Illustration of the interaction between DESL and PAN.

FIGS. 8A-B. A) TG and B) DTG profiles of lignin sample.

FIG. 9. Maximum tensile strength of PLA composites.

FIG. 10. Maximum tensile strength of HDPE composites.

FIG. 11. Maximum tensile strength of PETG composites.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Embodiments of the disclosure provide methods for producing lignin in a large quantity with high purity and controlled structural properties and chemical characteristics. The lignin products generated from this method encompass native-like lignin all the way to low molecular weight ether free lignin. These lignin products can be applied for preparation of composite materials, including but not limited to carbon fiber, plastics, thermoset polymers, thermoplastics, resin, adhesives, and specialty fibers.

The methods described herein include extraction of lignin from plant biomass with a deep eutectic solvent (DES) mixture comprising a heterocyclic compound. DESs are mixtures of two compounds with a melting point significantly lower compared to the starting materials. DESs combine a suitable hydrogen bond acceptor and a suitable hydrogen bond donor. The DES mixture described herein may comprise one or more of lactic acid, choline chloride, urea, and aniline. The heterocyclic compound may contain nitrogen, oxygen, sulfur, or phosphorus. The molar ratio of hydrogen bond donor (e.g. lactic acid) to heterocyclic compound may be from 10:1 to 1:10.

Heterocyclic compounds have an uneven distribution of electron density in their structures and this can strongly influence their interaction and reactivity with electron dense molecules. Lignin is an aromatic polymer with a higher electron-density than cellulose and hemicellulose. Example N-heterocycles include pyridine (Pyr), pyrrole (Pr), and pyrazole (Py). Depending on the lone pair of N atoms, N-heterocycles are separated into two groups: π-excessive or π-deficient. For example, pyrrole is a π-excessive heterocycle whereas pyridine represents π-deficient heterocycle. The electron donating or withdrawing ability of N-heterocycle may form unique interaction(s) with lignin. Meanwhile, the Lewis base properties of N-heterocycle can also lower the acidity of hydrogen bond donors (e.g. lactic acid) in DES which may minimize acid condensation reactions on lignin. In additional to N-heterocycles, heterocycles containing atoms with unpaired electron(s), e.g. O, S, P, can also be used.

As described herein, the DES solvent is mixed with a plant biomass. The term “plant biomass” refers to any cellulosic or lignocellulosic material and includes materials comprising polysaccharides, lignin, starch, oligosaccharides and/or monosaccharides. Biomass may also comprise additional components, such as protein and/or lipid. In some embodiments, the biomass is any tissue containing lignins or polyphenols. Biomass may be derived from a single source, or it can be comprised of a mixture derived from more than one source. For example, biomass can be a mixture of grass and leaves. Biomass also includes, but is not limited to, bioenergy crops, agricultural residues, municipal solid waste, industrial solid waste sludge from paper manufacture, yard waste, wood, and forestry waste. Biomass can also include crop residues such as corn husks, corn stover, potatoes and potato waste, grasses, wheat, wheat straw, barley, barley straw, hay, rice straw, switchgrass, waste paper, sugar cane bagasse, sorghum, soy, components obtained from processing of grains, trees, branches, roots, leaves, wood chips, sawdust, shrubs and bushes, vegetables, fruits, flowers, algae and animal manure.

After the DES is mixed with the plant biomass, the mixture is heated for a time period sufficient to release lignin from the plant biomass. For example, the mixture may be heated to a temperature of about 50° C. to 150° C., e.g. 90° C. to 145° C., for about 0.1 to 24 hours or more, e.g. about 3-12 hours. After heating, lignin can be extracted from the mixture using known techniques, e.g. via precipitation. In some embodiments, the desired end product is cellulose and/or hemicellulose which can be collected after removal of lignin. Thus, embodiments also include methods of extracting cellulose and/or hemicellulose from a plant biomass using a DES mixture as described herein. Embodiments of the disclosure also provide a composition containing lignin, cellulose, or hemicellulose extracted by a method as described herein.

As shown in the Example, mild extraction conditions (e.g. 90° C.-120° C.) can produce a light colored native-like lignin. Utilizing higher temperatures (e.g. 120° C.-150° C.) can produce ether linkage free lignin with low polydispersity. It was also shown that a higher hydrogen bond donor to heterocyclic compound ratio resulted in lower ether linkage content and subsequently lower molecular weight.

In some embodiments, an extraction yield of the lignin is at least 30%, e.g. at least 40%, 50%, 60%, 70%, 80%, or 90%. In some embodiments, the method has a lignin extraction selectivity of at least 0.35. Lignin extraction selectivity determination is calculated based on the equation: “Weight of extracted lignin”/“Weight of total soluble fraction”. The weight of total soluble fraction is calculated based on “Initial weight of biomass”−“Weight of residual pulp”. In some embodiments, a purity of the extracted lignin is at least 90%, e.g. at least 95%, 96%, 97%, 98%, or 99%. In some embodiments, the extracted lignin has a polydispersity index of 1.9 or lower.

Further embodiments include a method of preparing a composite material, comprising mixing lignin obtained according to a method as described herein with a polymer to form the composite material. In some embodiments, the polymer is selected from the group consisting of polyacrylonitrile (PAN), polylactic acid (PLA), polyethylene terephthalate glycol (PETG), and high-density polyethylene (HDPE). In some embodiments, the polymer may be selected from any thermoplastic or thermosetting polymer. In some embodiments, the method further comprises mixing a crosslinking agent with the lignin and polymer to form the composite material. In some embodiments, the crosslinking agent is a siloxane compound such as tetramethyl tetraphenyl trisiloxane (TTT) or tetraethoxysilane (TEOS). In some embodiments, the crosslinking agent is an organic acid, aldehyde, or amine. The method may further comprise mixing cellulose nanofibers with the lignin and polymer to form the composite material. In some embodiments, the mixing of the lignin and polymer is performed by extrusion, wet spinning, melting spinning, or casting. In some embodiments, a ratio of lignin to polymer is from 1:9 to 9:1.

Such composite materials may be useful as high performance materials such as thermoset, thermoplastics, carbon fibers, etc. Carbon fiber (CF) is one of the most promising materials, which is significantly used in the aerospace industry and could also reduce vehicles' weight and thus improve the economy in automotive industry. PAN is currently the major feedstock for carbon fiber manufacture. The high cost of PAN-based carbon fiber has prevented its mass application in automotive industry. Identifying low-cost new material for carbon fiber manufacture is of significant commercial interest. Lignin, the largest renewable aromatic polymer in nature, may be used as a blending component to PAN for CF manufacture. Blending various types of lignin in PAN often leads to low modulus and strength of resulting CF products.

Embodiments of the disclosure may provide a light color and odorless lignin that is of significant value. Previous lignin products are all in darker color. The present disclosure provides the first method which is capable of producing light color lignin in a large quantity which can be applied for, but not limited to, colorless films and coatings.

The present disclosure enables the homogenization of all types of lignin and realizes the design and fabrication of consequent lignin-based composite materials that can be reformulated to exhibit different ranges of hydrophobicity, flame retardancy, UV resistance, high strength, high stiffness, natural degradability, and biocompatibility. These characteristics offer the usage of lignin-based composite materials in a wide variety of applications, particularly in packaging (soft and hard), construction, automotive, aerospace, electronics, and biomedical industries.

While the present invention has been illustrated by the description of embodiments thereof and specific examples, and while the embodiments have been described in considerable detail, it is not intended to restrict or in any way limit the scope of the appended claims to such detail. Additional advantages and modifications will readily appear to those skilled in the art. Thus, the invention in its broader aspects is therefore not limited to the specific details, representative apparatus and methods and illustrative examples shown and described. Accordingly, departures may be made from such details without departing from the scope or spirit of applicant's general inventive concept.

It is to be understood that this invention is not limited to particular embodiments described herein above and below, and as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. at which the cell reaction takes place

The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1

Here, we developed an N-heterocycle based deep eutectic solvent with a binary hydrogen bonding functionality resulting in a high affinity toward lignin. Up to 93.7% of lignin was extracted from wheat straw biomass at varying conditions from 90° C. to 145° C. Through careful selection of treatment conditions, lignin with controlled levels of ether linkage content, hydroxyl group content, and average molecular weight can be generated. Under mild extraction conditions (90° C.-120° C.), light colored native-like lignin can be produced with up to 80% yield, whereas ether linkage free lignin with low polydispersity can be obtained at 145° C. Overall, this study offers a new strategy for native lignin extraction and generating lignin with controlled structural properties.

### Materials and Methods

### Materials

Hard red winter wheat straw was collected from south-eastern Washington. The wheat straw sample was air-dried and milled to a specific size (mesh −40/+60), which was composed of 22.4±0.1% lignin, 40.8±0.6% cellulose, 29.2±0.2% hemicellulose, and 3.4±0.3% ash, and 3.2±0.1% extractives. L(+)-Lactic acid (90% solution in water), ethanol (95%), choline chloride (99%), pyridine (99+%), and aniline (99+%) were purchased from Fisher Scientific. Pyrazole (>98%) was purchased from TCI America. Alkali Lignin (AL, CAS: 8068 May 1) and Technical Sodium Lignosulfonate (LS, CAS: 8061-51-6) samples were respectively purchased from Sigma-Aldrich and Spectrum Chemical. All chemicals were used as received.

### DES Preparation

DES preparation was carried out by mixing lactic acid with target materials (choline chloride, pyrazole, pyridine, and aniline) followed by stirring them at room temperature under inert gas until a homogeneous and transparent liquid was obtained. The molar ratio of lactic acid and target materials was 1:1 unless otherwise specified.

### General Procedure for Phenolics Treatment

0.1 g of phenolics (guaiacol, catechol, and isoeugenol) was added in 1 g of DES (La-ChCl or La-Py) in capped vessels (Parr bomb). The reactions were conducted at 120° C. for 9 hours under nitrogen gas atmosphere. After the reactions were completed, 10 μL of aliquot was collected and added in 0.6 mL of d-chloroform or d₆-DMSO for ¹H NMR characterization.

### General Procedure for Biomass Treatment

3 g of wheat straw sample was mixed with 30 g of DES in capped reaction vessels. The reactions were carried out in the presence of nitrogen at desired conditions, from 90° C. to 145° C. for 3 to 12 hours. After reactions, 20 mL of ethanol was first added in the vessel to help separate the solid fractions and DES soluble fraction. Then biomass and ethanol-DES solution were separated by filtration using a glass crucible with 20 mL of ethanol washing for 3 times. Solid residue was dried in the oven at 105° C. for 4 hours. DI water was added to the filtrate to precipitate lignin. Lignin was collected after centrifugation and washing with 10 wt % ethanol for several times. The ethanol was removed from the supernatant by vacuum evaporation at 65° C. and the ensuing DES/water solution was then dried in the oven at 105° C. for 4 hours to remove water and regenerate DES.

### Lignin Extraction Selectivity

Lignin extraction selectivity determination is calculated based on the equation: “Weight of extracted lignin”/“Weight of total soluble fraction”. The weight of total soluble fraction is calculated based on “Initial weight of biomass”−“Weight of residual pulp”. For example, the lignin extraction selectivity (LES) of La-ChCl treatment is (0.224*0.818)/(1−0.423)=0.318.

### Determination of Wheat Straw and Lignin Chemical Composition

The procedure to determine the chemical composition of biomass and lignin was conducted following Tappi Standard method T 222 om-02 and NREL procedures. Lignin purity is determined by insoluble klason lignin content in final lignin products. The hydrolysate samples were analyzed by high performance liquid chromatography (HPLC) to determine the sugar content using a Biorad Aminex® H column following previous procedures.

### 2D HSQC and ¹³C NMR Spectroscopic Analysis

2D ¹H-¹³C heteronuclear single quantum coherence (HSQC) NMR was used to characterize the chemical features of the extracted lignin. A 50 mg of lignin sample was dissolved in 0.6 mL of d₆-DMSO for NMR study. The experiment was conducted on a Varian® VNMRS 500 spectrometer equipped with both Varian® dual broad band (1-D) and HCN (2-D) probes. Pulsed field gradient coherence selection was used to acquire the 2D HSQC NMR spectra. 8012.8 Hz was used for ¹H dimensions while 25502.1 Hz was used for ¹³C dimensions. The acquisition time is set as 0.064 s for direct observation dimension, and 96 scans were taken per increment. A total of 256 increments in t1 and 512 complex points were acquired. HSQC spectra were processed and analyzed with MestReNova 6.0.4 (MestRelab Research), with matched cosine-bell apodization in both dimensions, 2× zero filling in both dimensions, and forward linear prediction of 30% more points in the indirect dimension. Chemical shifts were referenced to the central DMSO peak (δC/δH 39.5/2.5 ppm). Assignment of the HSQC spectra and semiquantitative analysis are applied from previous research.

The extracted lignin was acetylated prior to ¹³C NMR characterization. 0.1 g of lignin was added in 1 mL of pyridine and 1 mL of acidic anhydride solution, then reacted at room temperature. After 12 hours, the acetylated lignin was precipitated by adding 10 mL of DI water in the solution. The solid was washed with DI water and separated by centrifugation then freeze dried to get the acetylated lignin. ¹³C NMR was conducted on a Varian® VNMRS 500 spectrometer with a 90° pulse width, a 1.4 s acquisition time, and a 10 s relaxation delay. 50 mg of acetylated lignin samples were dissolved in 0.6 mL of d₆-DMSO with relaxation agent (Cr(acac)₃) to facilitate the relaxation of the magnetization.

### Phenolic Hydroxyl Analysis by UV-Vis Spectroscopy

The phenolic hydroxyl and conjugate phenolic hydroxyl contents in the extracted lignin were analyzed by UV-vis spectroscopy. The phenolic hydroxyl is bathochromic shifted after deprotonation to phenolate ion in strong basic solution. Therefore, the concentration of phenolic hydroxyl can be calculated by the adsorption difference between neutral and alkaline solution. 3 mg of lignin samples was totally dissolved in 3 mL of 0.2N NaOH solution as stock solution. Then, 0.12 mL of stock solution was diluted to 3 mL by pH=6 buffer solution (0.05M of monopotassium phosphate with 0.006M of NaOH) as neutral sample, and by 0.2N NaOH solution as alkaline sample, respectively.

The difference spectrum was determined by measuring the absorbance of the alkaline solution relative to that of the neutralized solution which was placed in the reference cell of the spectrophotometer as the “blank.” Readings were taken from 260 to 400 nm and scan speed 1 nm/s. Maxima at 295-300 nm are assigned to unconjugated phenolic structures (Phenol and guaiacol as standard) and that at 340-370 nm to conjugated structures (syringaldehyde as standard).

$$The phenolic hydroxyl content ( \text{mmol/g} ) = \frac{Δαmax ( lignin )}{Δαmax ( standard )}$$

$$Δαmax = \frac{A}{c \times l}$$

A: absorbance of λₘₐₓ C: concentration of solution l: length of cuvette

### Molecular Weight Distribution Analysis of Extracted Lignin

The molecular weight distribution of acetylated lignin was determined by gel permeation chromatography (GPC). 10 mg of sample was dissolved in tetrahydrofuran and then filtered through a 0.45 μm filter. A Perkin-Elmer High performance liquid chromatography (HPLC) equipped with a diode array detector (DAD) and three Agilent ZORBAX® PSM columns (60S, 300S, and 1000S) were used for GPC analysis of lignin molecular weight distribution. Tetrahydrofuran was used for eluent with a flow rate of 0.6 mL/min. Polystyrene standards (Alfa Acsar) with molecular weights ranging from 1,300 to 123,000 g/mol as well as veratrolc (138 g/mol) were used to calibrate the molecular weight based on retention time.

### DFT Calculation

The CREST utility of the xtb program was used to perform an initial search of the most stable conformers using semiempirical quantum mechanical method GFNn-xTB combined with the iMTD-GC (metadynamic sampling followed by genetic z-matrix crossing) workflow. Then, a more accurate search for the most stable conformers obtained by CREST was performed using Density-Functional theory (DFT). The NWChem software package was used for the DFT geometry optimization calculations. We have adopted the PBE0 hybrid Exchange-Correlation with the dispersion correction treatment as prescribed by Grimme's D3 method involving Becke-Johnson damping, in combination with a def2-TZVP Gaussian basis set.

### TGA Test

Thermogravimetric analysis (TGA) was tested on a TGA/DSC (Mettler Toledo) in nitrogen gas atmosphere. The temperature was heated up to 600° C. from room temperature at a heating rate of 60° C./min.

### Results

### Selection Test of N-Heterocycle DES

Three N-heterocycle compounds, pyridine (Pyr), pyrrole (Pr), and pyrazole (Py) were selected to form DES with lactic acid (La). In addition, lactic acid/choline chloride (La-ChCl), lactic acid/urea (La-Ur), and lactic acid/aniline (La-An) DES were tested to compare with the N-heterocycle based DES. Pyridine (π-deficient) contains C═N with a basic lone pair electron that withdraws electron density from the carbon ring, while pyrrole (π-excessive) and aniline contain C—NH with a lone pair electron delocalized to the π-conjugate system, which donates to the carbon ring. Pyrazole is a diazole with both C═N and C—NH. La-Ur is non-cyclic N containing DES, and La-ChCl has been repeatedly demonstrated to be highly efficient in extracting lignin from wood and grass with high yields. These six DES were prepared using La and N-compounds with a molar ratio of 1:1, and then tested in the treatment of wheat straw to determine their potential for lignin extraction. This treatment for selection test was conducted at 120° C. for 9 h, based on previous work using La-ChCl DES treatment. Lignin extraction yields varied from 8.3% to 81.8%, in increasing order of La—Pr (8.3%), La-An (35.9%), La-Ur (40.5%) and La-Pyr (50.9%), La-Py (80%), and La-ChCl (81.8%) (Table 1).

TABLE 1
Treatment of wheat straw biomass by different DESs.

| | | | | | Lignin |
|---|---|---|---|---|---|
| | | | Residual | Lignin | extraction |
| | Type of | | pulp yield | extraction | selectivity |
| DES^{[a]} | Nitrogen | Condition | (%) | yield (%) | (LES) |
| Choline | Salt | 120 °C 9 h | 42.3 | 81.8 | 0.32 |
| chloride | | | | | |
| Urea | Amide | 120 °C 9 h | 65.4 | 40.5 | 0.26 |
| Pyrrole | C—NH | 120 °C 9 h | >100 | 8.3 | n.a. |
| Pyridine | C═N | 120 °C 9 h | 71.5 | 50.9 | 0.39 |
| Aniline | C—NH2 | 120 °C 9 h | 68.7 | 35.9 | 0.26 |
| Pyrazole | C═N + | 120 °C 9 h | 55.8 | 80.0 | 0.41 |
| | C—NH | | | | |

^{[a]}Formed with 1 molar lactic acid.

Pyrrole-based DES (La—Pr) clearly had the lowest yield, while pyrazole-based DES (La-Py) resulted in a high yield similar to La-ChCl. It was found that pyrrole is a reactive compound which self-polymerizes; although it can form a DES with lactic acid at room temperature, it appears to polymerize with the substrates at 120° C. After treatment, the solid residue has low solubility in ethanol which resulted in a low lignin extraction yield and a higher residual pulp yield than the initial weight of wheat straw. It is also observed that La-Pyr was more effective than La-An and La-Ur for lignin extraction. Treatment with the non-cyclic DES, La-Ur, led to a higher lignin extraction yield than with La—Pr and La-An. For comparison, we also tested the treatment through La-Py DES with excess pyrazole (molar ratio of 1:2 to 1:5), which significantly decreased the lignin extraction yield down to 48%. This was because the excess pyrazole neutralized the DES to pH=6. This indicated that even though pyrazole enabled to provide strong interactions between DES and lignin, sufficient amount of acidity was still needed for lignin extraction. The lignin extraction selectivity (LES) of the six DES were also compared, calculated as the weight ratio of extracted lignin vs total dissolved biomass:

$$L E S = \frac{Weight of extracted lignin}{Weight of total soluble fraction}$$

Although the lignin extraction yield differed considerably between La-Py and La-Pyr, both showed high LES values of 0.41 and 0.39, respectively, compared to the LES of La-ChCl at 0.32. The LES values of La-An (0.26) and La-Ur (0.26), were lower than that of La-ChCl. Comparing La-Pyr and La-An, it appears that the electron withdrawing nitrogen attached on the ring has a higher affinity toward lignin. Pyrazole contains both —C═N and —C—NH, and this binary functionality can enhance the strength of hydrogen bonding to a greater extent. The exceptional lignin extraction capability of La-Py is an exciting new finding. We next focused our investigation toward confirming and delineating the efficacy of La-Py for lignin extraction.

### Study of Molecular Interactions

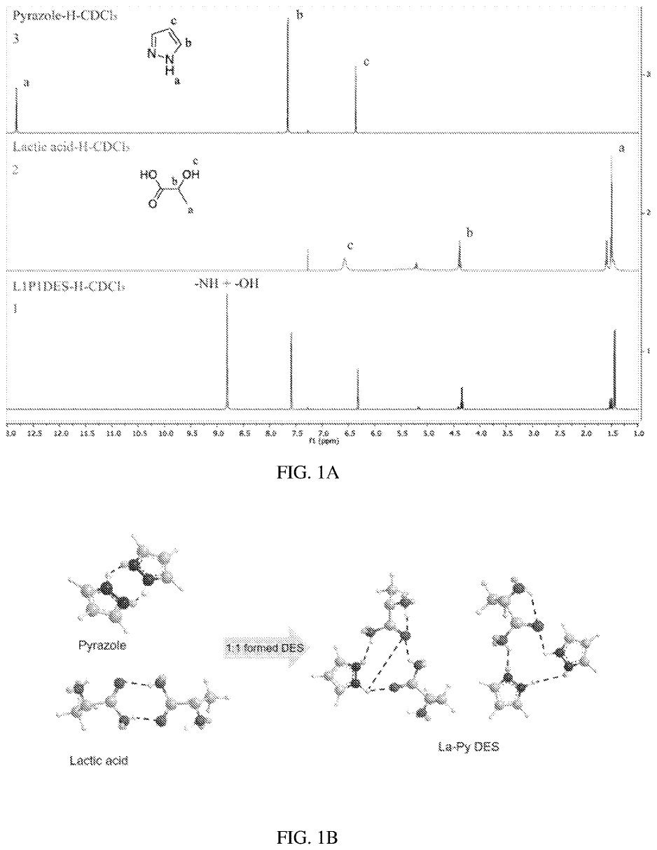

¹H Nuclear magnetic resonance spectroscopy (NMR) was first applied to determine hydrogen bonding interactions in La-Py DES. Here, stronger hydrogen bonding shifts the proton downfield due to de-shielding of electron density. As shown in FIG. 1A, both the —NH of pyrazole and —OH of lactic acid shifted from 12.82 ppm and 6.58 ppm, respectively, to 8.82 ppm after forming DES mixture. This chemical shift confirmed that hydrogen bonding formed between pyrazole and lactic acid. A schematic illustration of hydrogen bonding interactions in La-Py is shown in FIG. 1B. The presence of C═N and C—NH in the respective 1, 2-positions on pyrazole enables the formation of a trimer through the hydrogen bonding of both C═O . . . H—N, and O—H . . . N═C between azole and carboxylic acid. This unique interaction distinguishes La-Py from all other DES mixtures, which typically have one type of hydrogen bond connecting the designated hydrogen bond donor (HBD) and hydrogen bond acceptor (HBA). Single crystal structure analysis has shown that nitrogen atoms in pyrazole can strengthen the hydrogen bonding with aromatics and phenolics. Pyrazole can function as both HBA and HBD in the donor-acceptor system which may afford its high affinity to lignin through hydrogen bonding to phenolic/aliphatic hydroxyl groups. To confirm this hypothesis, we treated guaiacol, catechol, and isoeugenol with La-Py DES at 120° C. After the treatment, the DES and phenolic compounds mixtures were analyzed by 1H NMR. The chemical shifts of —NH peak in pristine La-Py DES as well as La-Py DES solutions after reaction with respective guaiacol, catechol, and isoeugenol, were observed. As mentioned, the —NH in pristine La-Py DES was at 8.82 ppm. After reaction with these phenolic compounds the —NH in La-Py DES all shifted to lower field (higher ppm) between 10.12-10.35 ppm. The chemical shift suggested that La-Py DES can form new and stronger hydrogen bonds with phenolic compounds. An increase in hydrogen bonding typically causes a chemical shift of proton to lower field (higher ppm), as a stronger hydrogen bond can withdraw more electron density from the proton. Guaiacol, catechol, and isoeugenol resemble common monomeric constituents of lignin. Therefore, it is likely La-Py DES will have a high affinity to lignin or its fragments.

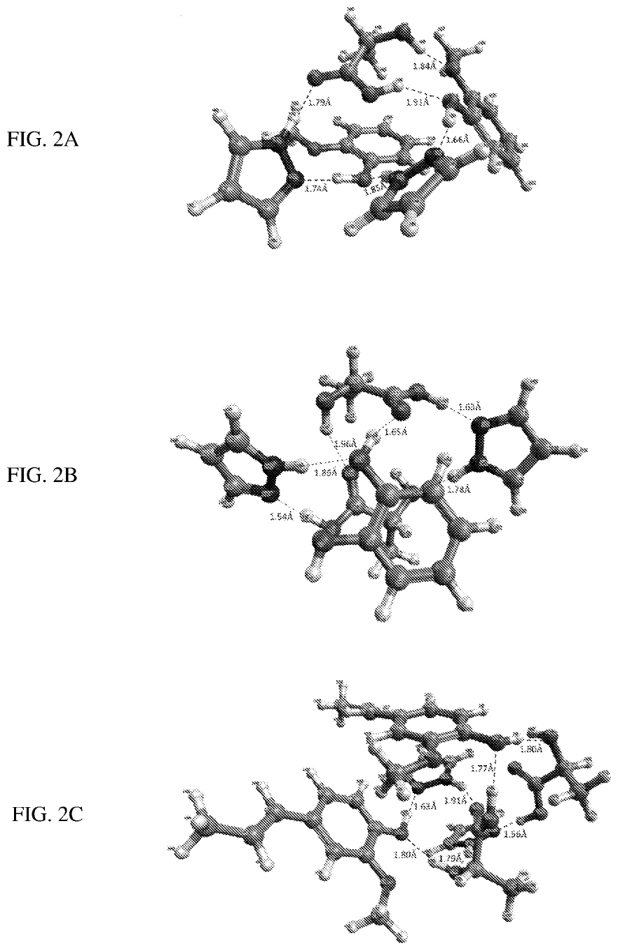

To better understand the interactions of lignin-phenols and La-Py DES, density functional theory (DFT) calculations were performed. The optimized structures of guaiacol, catechol, isoeugenol with La-Py DES are shown in FIGS. 2A-C. It appears that pyrazole and lactic acid form strong hydrogen bonds C═N . . . H—O (1.54 Å-1.74 Å), N—H . . . O (1.63 Å-1.91 Å), and O—H . . . O (1.65 Å-1.96 Å) with lignin-phenolics. Comparing with La-ChCl DES only form one or two hydrogen bonding with lignin-phenolics, the binary functional pyrazole can form multiple hydrogen bonds with lignin, thereby resulting in higher affinity to lignin. In addition, the electron withdrawing nitrogen has stronger hydrogen bonding interaction compare with electron donating nitrogen or hydroxyl indicating that the extraction yield correlates to hydrogen bonding interactions.

It was also found from both ¹H NMR and ¹³C NMR analyses that no condensation occurred between these phenolic monomers during La-Py treatment. In contrast, treatment of isoeugenol by La-ChCl at 120° C. led to the formation of new linkages, based on new peaks detected in the C—C and C—O aromatic region (130 ppm to 150 ppm). This condensation mechanism likely occurred between the alkene side chain and aromatic ring, similar to the benzylic cation condensation observed during acid extraction. The color of isoeugenol solution also became dark after La-ChCl DES treatment. The results from the model compounds study confirmed the formation of strong hydrogen bonding between La-Py and phenolic hydroxyl groups and brings new insight that La-Py extraction can minimize lignin structural changes.

### Treatment of La-Py DES on Wheat Straw Biomass

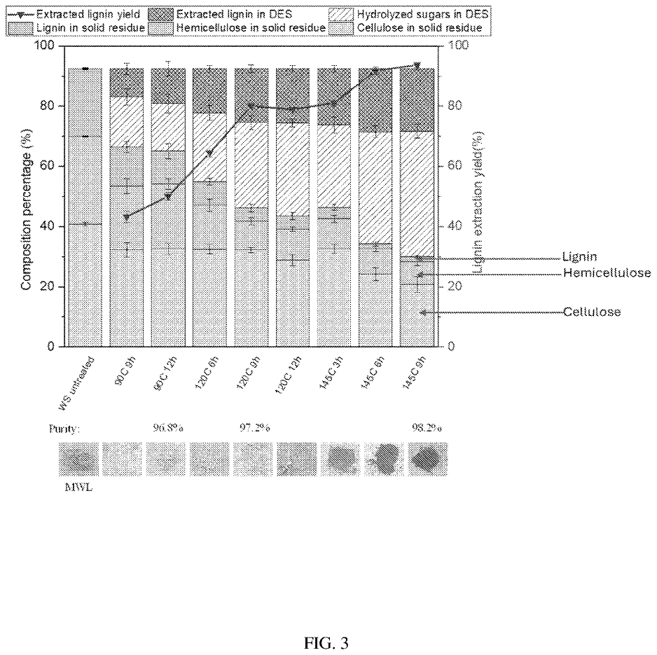

To gain a more comprehensive understanding of La-Py extraction of lignin from biomass, treatments of wheat straw at different conditions (90° C. for 9, 12 h; 120° C. for 6, 9, 12 h; 145° C. for 3, 6, 9 h) were conducted. These conditions were chosen based on our previous work on La-ChCl DES. As shown in FIG. 3, a lignin extraction yield up to 93% can be obtained. The resulting DES lignin have high purity with little residual carbohydrates. A detailed analysis of the carbohydrate and lignin mass balances before and after La-Py treatment at 120° C. for 9 h was also conducted to compare with La-ChCl treatment at the same condition. Both the lignin yield and purity obtained from these two treatments are similar. However, considerably more carbohydrates were retained in the solid residues after La-Py treatments, supporting the higher residual solids yield after La-Py treatment shown in Table 1. Our earlier work has shown that during La-ChCl treatment significant hydrolysis of hemicellulose accompanies lignin extraction. Substantial removal of hemicellulose is needed to facilitate high yield lignin extraction using La-ChCl and many other types of DES. However, the same lignin extraction yield was obtained with much less hemicellulose hydrolysis during La-Py treatment. This further substantiates the fact that La-Py has a high affinity toward lignin, facilitating selective lignin extraction.

While higher temperatures led to greater lignin extraction yields, it was also noted that the color of the resulting lignin changed from pale yellow to light brown to dark brown as the extraction severity increased. The lignin fractions obtained after 90° C. for 12 h, 120° C. for 9 h, and 145° C. for 9 h were designated as LaPy90L12 h, LaPy120L9 h, and LaPy145L9 h, respectively. Native-like lignin has a light color, varying between pale yellow to beige depending on the feedstock. Lignin is susceptible to structural modifications under chemical, physical and thermal treatments that can darken the lignin product. This is primarily due to the formation of chromophore structures such as conjugated carbonyls, phenoxyl radicals, quinones, or stilbenes quinones during these treatments and subsequent reactions. It is surprising that the lignin samples produced from La-Py treatments at 90° C. and 120° C. maintained a light color similar to milled wood lignin (MWL), suggesting that minimal structural alterations occurred during these treatments. In contrast, lignin obtained from La-Py treatments at 145° C. and La-ChCl DES extracted lignin (LaChCl120L) have shown darker color. As both LaPy90L12 h and LaPy120L9 h were obtained in high yield (50.1% and 80%) and high purity (96.8% and 97.2%) compared to MWL, one can certainly speculate that these lignin samples may better represent native lignin. Thus, we next conducted detailed analysis of the structural properties of lignin obtained from different DES treatment conditions.

### Characterization of Structural Properties of La-Py DES Extracted Lignin

LaPy90L12 h, LaPy120L9 h and LaPy145L9 h were further characterized by ¹³C NMR and 2D HSQC NMR. LaPy90L12 h has similar structural characteristics to those of MWL (Table 2) with a slightly lower ether linkage content (65.8/100Ar). The aliphatic and phenolic hydroxyl group content of LaPy90L12 h and MWL are almost the same. Compared to MWL, LaPy120L9 h has a lower ether linkage content and ~20% higher phenolic hydroxyl group content. The aromatic region of LaPy120L9 h showed a similar pattern to MWL with no condensed structures detected. Treatment of wheat straw at 145° C. yielded a lignin, LaPy145L9 h, with significant structural changes. Little ether linkage was detected in LaPy145L9 h with phenolic hydroxyl group content increasing to 2.00 mmol/g (see Table 2). New peaks observed at 105.1/6.53 ppm and 113.6/6.78 ppm suggested the formation of condensed structures. In comparison, LaChCl120L also has low ether linkage content and high total phenolic hydroxyl content, similar to LaPy145L9 h (Table 2). It is, however, interesting to note that the conjugated phenolic hydroxyl content is much higher in La-ChCl than in La-Py lignin samples. The presence of conjugated phenolic hydroxyl groups in lignin after ether cleavage will likely encourage condensation reactions to occur as well as increase the darkness of lignin.

TABLE 2
Structural properties of La—Py DES extracted lignin.

| | Chemical | | | | | |
|---|---|---|---|---|---|---|
| | shift (ppm)/ | | | | | |
| Spectral | wavelength | | | | | |
| region | (nm) | MWL | LaPy90L12h | LaPy120L9h | LaPy145L9h | La—ChCl120L |
| C_{α} in β-O-4^{[a]} | 71.6/4.84 | 58.0 | 52.5 | 39.0 | n.d | n.d |
| (per 100 | ppm | | | | | |
| aromatic) | | | | | | |
| C_{α} in β-β^{[a]} | 85.0/4.65 | 9.6 | 8.2 | 7.7 | n.d. | n.d. |
| (per 100 | ppm | | | | | |
| aromatic) | | | | | | |
| C_{α} in β-5^{[a]} | 87.0/5.45 | 6.7 | 6.3 | 5.6 | n.d. | n.d |
| (per 100 | ppm | | | | | |
| aromatic) | | | | | | |
| Total ether^{[b]} | | 74.3 | 65.8 | 52.3 | n.d. | n.d. |
| (per 100 | | | | | | |
| aromatic) | | | | | | |
| Total phenolic | 295 + 360 | 1.28 | 1.34 | 1.63 | 2.00 | 1.96 |
| hydroxyl^{[c]} | nm | | | | | |
| (mmol/g) | | | | | | |
| Conjugated | 360 | n.d. | n.d. | 0.04 | 0.08 | 0.33 |
| phenolic | nm | | | | | |
| hydroxyl^{[c]} | | | | | | |
| (mmol/g) | | | | | | |
| Aliphatic | 171-168 | 1.18 | 1.18 | 1.16 | 1.01 | 1.67 |
| hydroxyl^{[d]} | ppm | | | | | |
| (per C6 | | | | | | |
| aromatic) | | | | | | |
| Mn^{[e]} | | 1580 | 1550 | 1770 | 760 | 870 |
| Mw^{[f]} | | 3100 | 3650 | 3360 | 1050 | 1250 |
| PDI^{[g]} | | 1.96 | 2.35 | 1.90 | 1.38 | 1.44 |

^{[a]}Expressed as a number per 100 aromatic units (S + G + H);
^{[b]}Sum of β-O-4, β-β, and β-5 aryl ether;
^{[c]}Calculated by phenolate ion UV-vis spectroscopy method, mmol/g;
^{[d]}Calculated from ¹³C NMR, number per C6 aromatic;
^{[e]}Mn: number average molecular weight;
^{[f]}Mw: weight average molecular weight;
^{[g]}PDI: polydispersity index.

The molecular weight of LaPy90L12 h, LaPy120L9 h, and LaPy145L9 h was also determined by gel permeation chromatography (GPC). LaPy90L12 h has a similar Mn, but slightly higher Mw and polydispersity index (PDI) compared to MWL (Table 2). The Mn, Mw and PDI of LaPy120L9 h are comparable to those of MWL. The lignin extraction obtained from LaPy90L12 h was ~80% which is likely much higher than conventional milling process. Thus, DES extraction provides a better alternative lignin separation method. Increasing extraction temperature to 145° C. led to significant reductions in Mn, Mw and PDI, confirming that LaPy145 can intensify the cleavage of ether linkages leading to lignin fragmentation (LaPy145 denotes the treatments occur at 145° C.). The low PDI of LaPy145L (denotes lignin sample) suggests that the low molecular weight lignin fragments obtained have more uniformed size distributions. Previous results obtained from La-ChCl extraction of different plant biomass have also yielded DES lignin with more uniform size distributions. However, HSQC NMR analysis showed that La-ChCI treatment of wheat straw at 120° C. for 9 h can cause condensation reactions on both G and S units. Lignin condensation can be initiated by dehydration of aliphatic hydroxyl groups or β-5 ether linkages to form a reactive conjugate side chain, i.e. enolate ether or conjugate carbonyls.

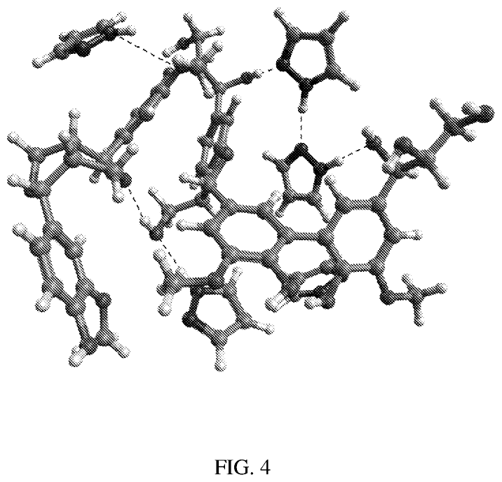

Condensed structures obtained from La-Py treatment under the same conditions (120° C. for 9 h) was not observed in LaPy120L. But under elevated La-Py treatment temperature, 145° C., condensed structure started to appear in LaPy145L9 h. To better understand these “puzzled observations”, HSQC NMR spectrum of LaPy90L12 h, LaPy120L9 h, and LaPy145L9 h were further analysed. Both LaPy90L and LaPy120L have shown residual pyrazole attachments (104.7/6.19 ppm and 138.3/7.45 ppm). While these residual pyrazole attachments are absent in LaPy145L. As illustrated by DFT simulation (FIG. 4), the hydrogen bonding interactions between pyrazole and the hydroxyl groups in the extracted DES lignin can prevent further reaction of DES lignin. It is possible that these interactions are labile at 145° C. The detachment of pyrazole likely occurred during 145° C. treatments before the extraction was completed, which can expose hydroxyl groups to condensation reactions.

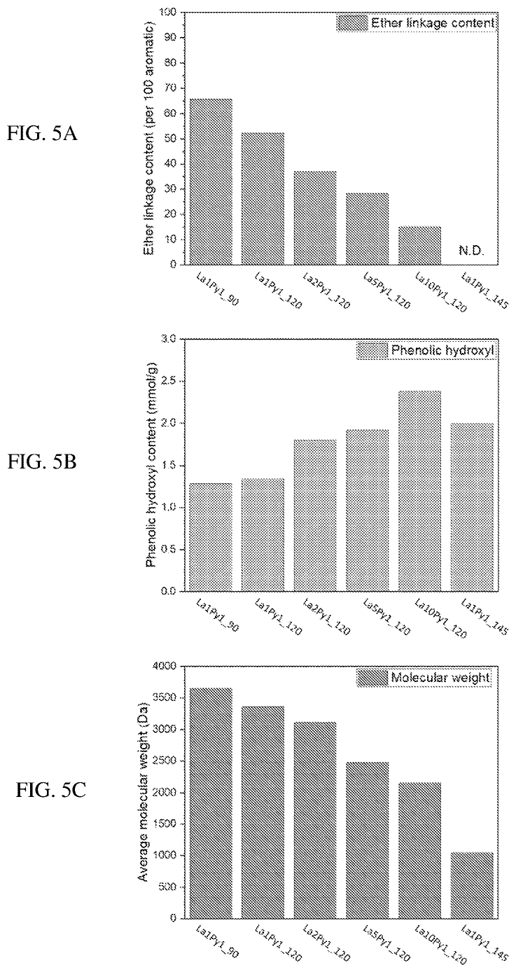

Lignin extractions by DES mixtures with different lactic acid to pyrazole ratios (from 1:1 to 10:1 molar ratio) were conducted at 120° C. for 9 h. A higher lactic acid to pyrazole ratio resulted in lower ether linkage content and subsequently lower molecular weight. The ether content changed from 53.6% to 15.1% when the lactic acid to pyrazole ratio increased from 1 to 10 molar. It is apparent that changing lactic acid to pyrazole ratio did not cause condensation reaction under this condition. The results confirmed that lactic acid is responsible for ether bond cleavage. Pyrazole is a Lewis base which can provide a buffering effect to Lewis acids. Therefore, the extent of ether cleavage can be regulated by the ratio between lactic acid and pyrazole. The cleavage of ether bonds led to an increase in phenolic hydroxyl group content. Thus, by adjusting the La-Py ratio as well as the treatment conditions, lignin with targeted levels of ether content, phenolic hydroxyl group content and average molecular weight can be generated (FIG. 5). No prior lignin extraction or processing methods have achieved this level of control toward lignin structural characteristics.

### Techno-Economic Analysis (TEA) of Lignin Extraction by La-Py DES

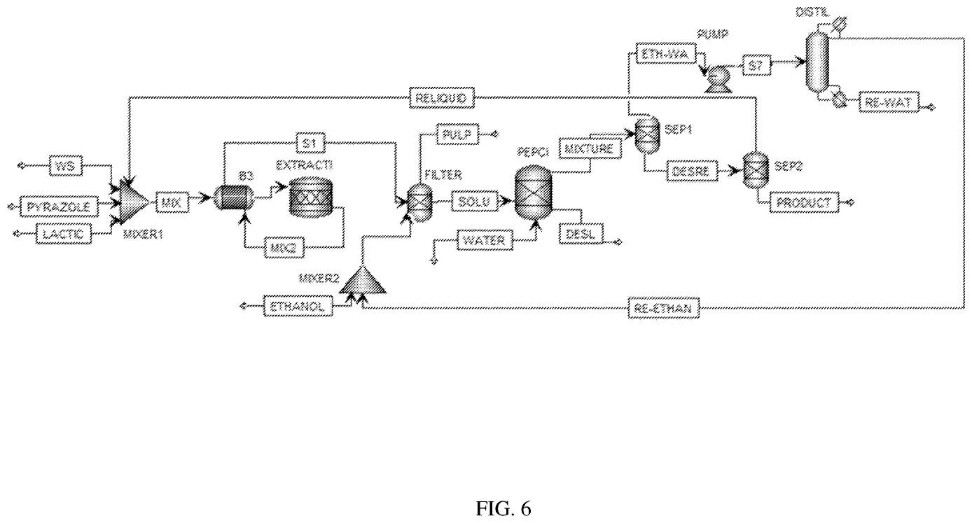

TEA is usually used to evaluate the commercial feasibility of a project in technical and economic aspects. FIG. 6 shows the Aspen Plus simulation process of lignin extraction from wheat straw by La-Py DES. Three main parts can be observed in this model flow sheet: DES extraction, lignin separation, and chemicals recovery. Wheat straw along with DES were fed to a Parr reactor for lignin isolation. After extraction at desired temperatures and durations, ethanol was added to separate solid pulp from DES soluble liquid fraction. Water was then added to the liquid fraction for lignin precipitation. Ethanol and water can be recovered and reused through distillation process.

### Discussion

La-Py extraction of biomass provides an unprecedented and novel method to produce lignin with high yield, purity and more importantly with controlled structural properties (e.g. Mw, ether linkage content, hydroxyl group content). It has been debated whether the separation of lignin through milling and combining with cellulase enzyme and/or solvent treatment (CEL, MWL) can truly yield representative native lignin from the whole plant. Physical separation methods tend to extract disproportional amounts of lignin from either compounded middle lamella or secondary cell wall, which are known to have contrasting structural characteristics. Mild milling conditions usually result in low lignin separation yields (less than 50%) whereas severe conditions led to lignin structural changes. MWL and CEL often contain an appreciable amount of residual carbohydrates. It is apparent that LaPy90 and LaPy120 treatments can extract lignin from wheat straw with high yield and high purity. LaPy90L12 h and LaPy120L9 h have exhibited comparable structure characteristics to MWL, yielding alternative lignin samples that perhaps better represent the structural characteristics of native lignin throughout the entire plant, and provide an opportunity for more accurate lignin analysis. Compared to native or industrial lignin, the ether linkage-free LaPy145L9 h may have enhanced thermostability for polymer synthesis. The thermostability of three lignin samples, LaPy145L9 h, AL, and LS, were determined. It is apparent that LaPy145L9 h has a better thermostability than both AL and LS samples before the temperature reached 260° C. However, LaPy145L9 h is more susceptible to thermal decomposition at elevated temperature range. The initial weight loss occurred at around 100° C., which was due to loss of moisture and volatile components. The 2^{nd} major weight loss occurred during the temperature range between 275-310° C., which was attributed to the cleavage of side groups such as —OH, —COOH, —OCH₃, etc. It was also noted that LaPy145L9 h sample herein showed a sharp peak, which is probably due to its high hydroxyl group content. Thermal depolymerization of lignin backbone started at about 325° C. on LS, and then at 375° C. on AL. The thermal depolymerization of LaPy145L9 h started at about 425° C., which was clearly higher than both AL and LS. The results suggested that the uniform structural properties and predominant C—C linkage afforded LaPy145L9 h an excellent thermostability under 260° C. which is adequate for most of polymer processing. The high C—C linkage content also improved thermal depolymerization of lignin. However, LaPy145L9 h has a relatively low molecular weight compared to other two lignin, thus at evaluated temperatures, it decomposed more rapidly.

In summary, we demonstrated that lactic acid and pyrazole DES has an exceptional capability for extracting lignin from plant biomass. The —C—NH and —C═N in the pyrazole provide a unique hydrogen bonding network in the DES formed with lactic acid. La-Py DES has shown a high affinity to lignin and can selectively extract lignin from wheat straw with high yield (up to 93%) and high purity (up to 98%). By adjusting the treatment conditions as well as the ratio between lactic acid and pyrazole in the DES mixture, lignin with targeted levels of ether linkage and phenolic hydroxyl group contents as well as average molecular weight can be produced. La-Py DES extraction provides a breakthrough in generating lignin from biomass in large quantities with high purity and controlled structural properties.

### Example 2

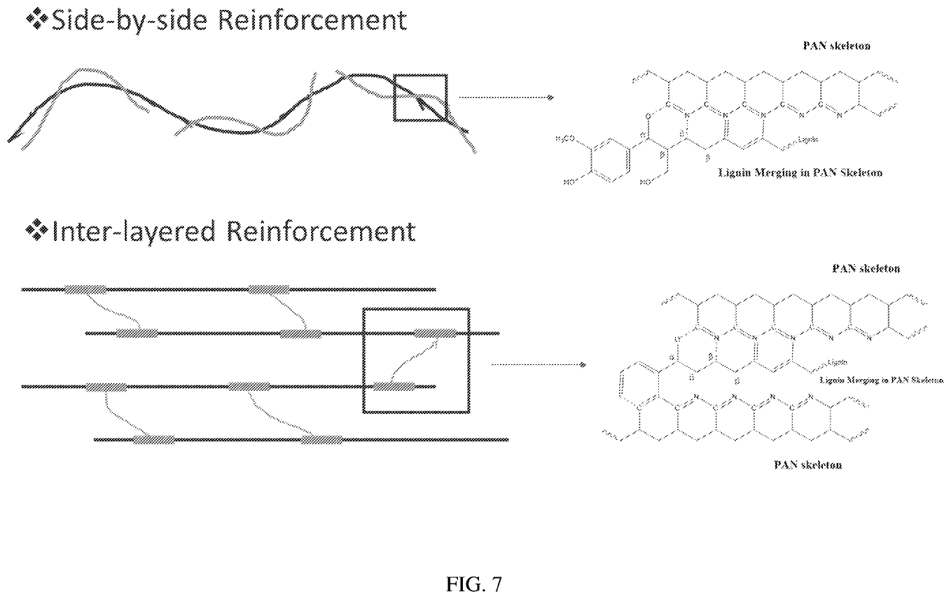

An ether-free lignin sample was mixed with PAN to prepare composite materials (FIG. 7). The composite material preparation method can be, but not limited to, extrusion, wet spinning, melting spinning, and casting. It was found that the lignin was dispersed well within PAN and subsequently formed a strong and homogenized material by casting and wet-spinning methods. The structural integrity of the materials is well maintained at a lignin content of even over 70 wt %. Both the functional groups and the molecular weight of this unique lignin contribute to its strong binding with PAN. The composites can be prepared by solution mixing of lignin and PAN at a weight ratio between 1:9 to 9:1. The ensuing composite material can maintain their structural integrity even at very high lignin dosage (up to 90 wt. % lignin) with good mechanical properties.

### Example 3

Another example application of the ether-linkage free low molecular weight lignin is to prepare thermoset. The lignin can be well-dispersed within other polymers in solvent or molten state to form composites as precursors. The lignin-polymer mixture is used to produce lignin-polymer composite by existing technologies (e.g., wet spinning, extrusion, melt spinning, 3D printing). We have printed controlled pure PLA and 20% lignin-PLA composite with ASTM D638 Type IV standard by additive manufacturing techniques.

### Example 4

Siloxanes are a group of substances characterized by Si—O—Si functional group. Siloxanes can react with alcohols to form Si—O—C bond. Siloxanes have been widely used as crossing linking agents and graft copolymers as well as additives for plastics. Lignin contains both phenolic and aliphatic hydroxy groups which have the potential to instigate bonding with siloxane compounds. However, there has not been any attempt to apply siloxanes as crosslinking agents for biobased composite formation. This example presents the first study of applying siloxanes compounds to lignin and Cellulose nanofibers including but not limited to cellulose nanocrystals (CNC), cellulose nanofibrils (CNF), or cellulose nanofilaments (CF) with respective PLA, PETG, and HDPE to prepare biocomposites. Both Tetramethyl Tetraphenyl Trisiloxane (TTT) and Tetraethoxysilane (TEOS) were used as cross-linking agents. We have successfully incorporated 20 wt % lignin and 10 wt % CNF into the biocomposite filaments. The tensile properties of ensuing biocomposite were investigated. The objective of this work is to demonstrate the potential of lignin and CNF as a sustainable co-polymer to improve the properties of PLA/PETG/HDPE-based materials for 3D printing.

### Materials and Methods

### Materials

The study encompasses three polymer matrices-PETG, HDPE, and PLA-chosen for their diverse properties. PETG (Polyethylene terephthalate glycol) is a thermoplastic polyester that has significant chemical resistance, durability, high impact resistance, and is better suited to higher temperatures. HDPE (High Density Polyethylene) is a thermoplastic polymer made from petroleum and is known for its outstanding tensile strength, high impact resistance, and melting point. PLA (Polylactic acid) is a thermoplastic polymer derived from renewable sources such as corn starch or sugar cane. PLA demonstrates high mechanical strength, good processing ability with low shrinkage, and is completely biodegradable. PETG and PLA pellets were purchased from 3DXTECH (Grand Rapids, MI, United States). HDPE pellets were purchased from Premier Plastic Resins (Lake Orion, MI, United States).

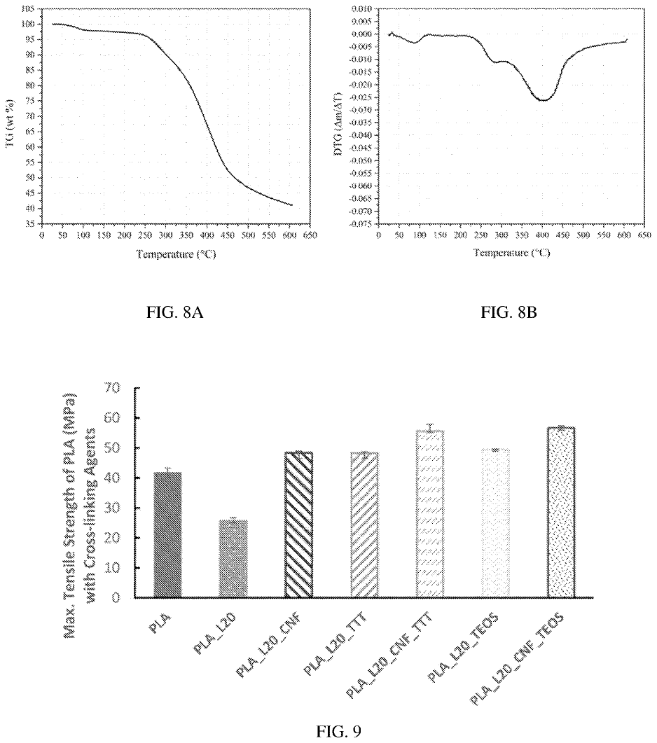

Lignin, a natural polymer commonly found in plant cell walls, is a renewable and biodegradable material that can be extracted from various sources such as wood, grasses, and agricultural residues. The lignin used in this study was extracted from pine wood by deep eutectic solvent (DES), the steps of which can be found in the above Examples. DES is a mixture of two or more chemicals acting as either hydrogen-bond donors (HBD) or hydrogen-bond acceptors (HBA). In this study, the DES was prepared using a 2:1 M ratio of lactic acid and choline chloride (La-ChCl). A 10:1 mass ratio of DES and pine wood (16-40 mesh) are then mixed and treated at 145° C. for 6 hours in a Parr reactor in nitrogen atmosphere. After DES treatment, anhydrous ethanol was added to the Parr reactor to separate the remaining solid from the DES and dissolved organics. The ethanol soluble fraction containing dissolved lignin and hemicellulose was collected after filtration. Then deionized water was added to this filtrate to precipitate lignin. Following air drying, the lignin was grounded into particles with a size of 16-40 mesh. The pine wood biomass was provided by Idaho Forest Group (Coeur d′Alene, Idaho, United States). Based on the characterizations, the DES lignin has a total-OH number of 4.94 mmol/g including aliphatic-OH, phenolic-OH, and carboxylic-OH. The peak molecular weight (Mp, Da) of DES lignin is 762.12. In addition, TGA profile proceeds to provide insights into the thermal behaviors of lignin samples. As illustrated in FIGS. 8A-B, the initial phase within 80° C.-120° C. reflects the mass associated with volatilization of free and bound water. When the temperature rises toward 275° C., further mass loss is detected which is primarily due to the cleavage and release of labile side groups including —OH, —COOH, —OCH₃, or possible breakdown of residual ether bonds. At a higher temperature, 375° C.-425° C., the weight loss is caused by thermal degradation. The DES lignin was selected to prepare the biocomposites in the present work.

Two cross-linking agents are incorporated to enhance the three thermoplastic polymers properties. 7044B vacuum diffusion oil (Tetramethyl Tetraphenyl Trisiloxane (TTT)) is a commercial silicone oil that has a strong attraction to both lignin and the polymer matrix. Tetraethoxysilane (TEOS) is silane compound which forms bonds with hydroxyl groups found in both lignin and the polymer matrix. TTT and TEOS were provided by BSEL (Richland, WA, United States). Cellulose nanofibers are made from wood-derived fiber (pulp) that has been micro-refined to the nano level. Cellulose nanofibers retain most of the characteristics of cellulose with low density, biodegradability, and biocompatibility, but also possesses other excellent properties such as high specific surface area, large aspect ratio, high crystallinity, and high surface activity. A dried, powdered form of CNF was purchased from Sappi (Boston, MA, United States). Sappi has reported the length of the fibers to be between 70 nm-5 μm, the diameter between 4-30 nm, the modulus of elasticity to be 70 GPa, and the tensile strength to be 700 MPa (Sappi Global, 2024).

### Methods

### Sample Preparation

PLA, PETG, and HDPE pellets were pre-dried in the Fisher Isotemp® Vacuum Oven (Model 281) at 60° C. for 3 hours before being mixed with the lignin, CNF, and cross-linking agents. The composition of the filaments that were prepared in this study is presented in Table 3. As shown, different ratios of lignin, CNF, and cross-linking agents blended with filaments. The pellets were first manually mixed with the lignin and cross-linking agents before feeding into the twin extruder (20 mm Twin Screw Extruder LTE20, CA, United States). The twin-screw extruder has ten temperature zones, and they were set as follows from zone 1 to 10 for PLA: 154.44° C., 165.56° C., 168.33° C., 168.33° C., 168.33° C., 168.33° C., 171.11° C., 171.11° C., 171.11° C., 172.78° C. PETG was set to 204.44° C. and HDPE was set to 254.44° C. for all ten zones. The screw speed starts at approximately 20 rpm (revolutions per minute) to push the material to the front of the extruder and was decreased to approximately a speed of 13-14 rpm. Reducing the rpm in the twin extruder slows the rotation of the two screws and enhances material mixing, ensuring a more homogeneous blend. The lowered rpm minimizes shear stress, preventing uneven melting and degradation, contributing to a smoother and more uniform extrusion process. Also, the reduced rpm facilitates improved temperature control, allowing for a more even distribution of heat and preventing localized overheating. The filaments obtained were varying diameters ranging from 1.70 mm to 1.80 mm.

TABLE 3
Filament composition prepared and sample code.

| | PLA | PETG | HTPE | Lignin | CNF | TTT | TEOS |
|---|---|---|---|---|---|---|---|
| Sample code | (wt %) | (wt %) | (wt %) | (wt %) | (wt %) | (μl) | (μl) |
| PLA | 100 | — | — | — | — | — | — |
| PLA_L20 | 80 | — | — | 20 | — | — | — |
| PLA_L20_CNF | 70 | — | — | 20 | 10 | — | — |
| PLA_L20_TTT | 80 | — | — | 20 | — | 42 | — |
| PLA_L20_CNF_TTT | 70 | — | — | 20 | 10 | 42 | — |
| PLA_L20_TEOS | 80 | — | — | 20 | — | — | 42 |
| PLA_L20_CNF_TEOS | 70 | — | — | 20 | 10 | — | 42 |
| PETG | — | 100 | — | — | — | — | — |
| PETG_L20 | — | 80 | — | 20 | — | — | — |
| PETG_L20_CNF | — | 70 | — | 20 | 10 | — | — |
| PETG_L20_TTT | — | 80 | — | 20 | — | 42 | — |
| PETG_L20_CNF_TTT | — | 70 | — | 20 | 10 | 42 | — |
| PETG_L20_TEOS | — | 80 | — | 20 | — | — | 42 |
| PETG_L20_CNF_TEOS | — | 70 | — | 20 | 10 | — | 42 |
| HDPE | — | — | 100 | — | — | — | — |
| HDPE_L20 | — | — | 80 | 20 | — | — | — |
| HDPE_L20_CNF | — | — | 70 | 20 | 10 | — | — |
| HDPE_L20_TTT | — | — | 80 | 20 | — | 42 | — |
| HDPE_L20_CNF_TTT | — | — | 70 | 20 | 10 | 42 | — |
| HDPE_L20_TEOS | — | — | 80 | 20 | — | — | 42 |
| HDPE_L20_{——}CNF_TEOS | — | — | 70 | 20 | 10 | — | 42 |

### 3D Printing of Filaments

A 3D CAD model for dynamic mechanical analysis (DMA) were prepared using Solidworks®. A dog bone sample following the ASTM D638 type V dimensions was prepared. The Solidworks® files were converted into .STL files and imported into the Prusa® software for 3D printing. Filament with a diameter in the range of 1.4-1.8 mm were selected and used for 3D printing using the Prusa® MK3S+ (Prague, Hlavni mesto Praha, Czech Republic). The printer had a nozzle diameter of 0.4 mm and was set at a temperature of 200° C. for PLA, 260° C. for PETG and HDPE.

### Characterization Methods

Differential Scanning calorimetry (DSC) was performed using a 214 Polyma® (NETZSCH, Selb, Bayern, Germany), operated under a nitrogen atmosphere at the flow rate of 40 mL/min. The samples, weighting from 5-10 mg, were first heated to 300° C. from room temperature at a heating rate of 10° C./min and then were cooled from 300° C. to 40° C. at a cooling rate of 10° C./min. The functional groups on the lignin and foam samples were characterized by Fourier-transform infrared spectroscopy (FT-IR, Shimadzu). Mechanical properties of filaments were measured using a Tensile/Flexural Machine assembled in lab. The loading cell used was model MLP-750 with a capacity of 750 Lbs (Transducer Techniques, Temecula, CA, United States). The tensile tests were carried out on five specimens for each composition, and the average values were reported.

### Results and Discussion

After incorporation of lignin, there was a slightly lower T_{g} for both PLA and PETG composites. However, this is contrary to HDPE composite, the T_{g} of which increased to around 160° C. from about 133° C. In the FT-IR spectra of the three composites, the broad troughs between wavenumber 2900-3,000 cm⁻¹ (carboxylic —O—H) and ranging around 3,300-3,500 cm⁻¹ (alcoholic —O—H) are missing completely, which indicates they go to form ester linkage. The C—O double bond stretch in ester functional group is located at around 1745 cm⁻¹. The peak ranging from 1,150-1,250 cm⁻¹ is the asymmetric C—C—O stretch. The vibration shifts in the range of 1,050-1,100 cm⁻¹ representing the asymmetric O—C—C stretch. For both pre- and post-addition of lignin, all the adsorption peaks fall into the same range of chemical shifts, which indicates that addition of lignin has a slight effect on the cross-linking in forming PLA composites. The CNF is rich in hydroxyl groups, so CNF addition leads to an increased density of ester bonds, which can be proved by the sharper peaks appearing in FT-IR spectra.

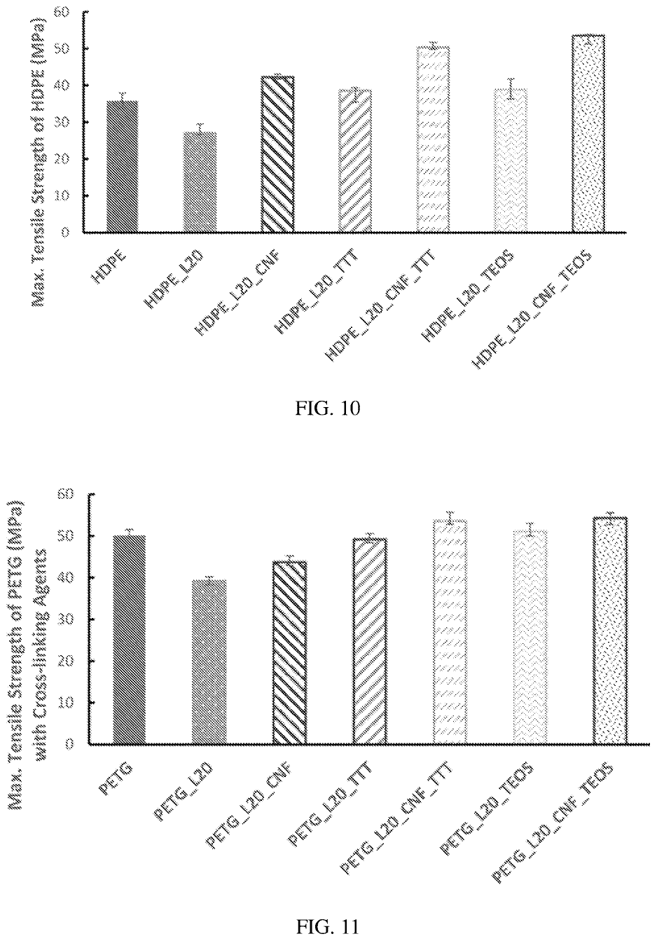

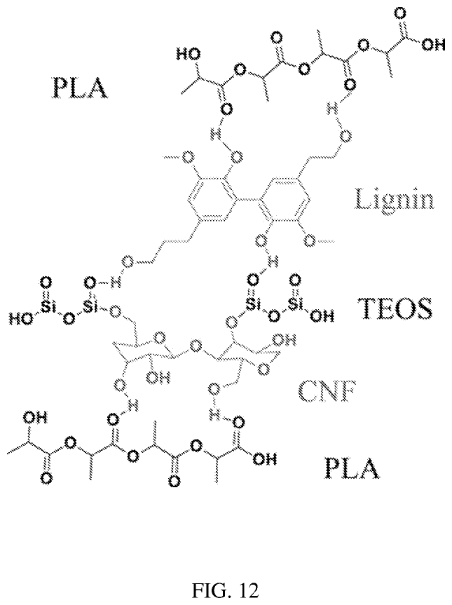

The results of mechanical testing of PLA, PETG, and HDPE composites with the incorporation of lignin, CNF, and the cross-linking agents are presented in FIGS. 9-11. On the whole, according to the results, adding more than 10 wt % CNF in PLA showed poor mechanical properties even though we successfully produced filaments. Therefore, two different cross-linking agents, a 704BB vacuum diffusion pump oil Tetramethyl Tetraphenyl Trisiloxane (TTT) and Tetraethoxysilane (TEOS), were added in with the blending process of the three thermoplastics. TTT is a silicone-based substance that stands out for its strong attraction to both lignin and the polymer matrix. When added to the polymer blend, it forms networks through physical entanglement and weak chemical interactions. This process enhances the material's toughness, impact resistance, and elongation properties. Also, the compatibility of this oil with lignin helps evenly disperse lignin particles within the polymer matrix, further improving mechanical properties and ensuring a uniform structure. TEOS is a silane compound which forms bonds with hydroxyl groups found in both lignin and the polymer matrix. This chemical bonding creates a strong network that improves thermal stability, chemical resistance, and dimensional stability of the material. Additionally, the silica-rich nature of TEOS cross-linking enhances the material's fire resistance, making it a promising choice for applications where safety is a top priority.

The results in FIGS. 9-11 indicate that with the addition of lignin in PLA, PETG, and HDPE, the tensile strength of the composites decreases. There is an approximate 30% decrease in the tensile strength with a 20 wt % addition of lignin. With the addition of 10 wt % of CNF the tensile strength increases for all thermoplastics, averaging 44 MPa, which is stronger than both pure PLA and pure HDPE. The positive impact of the nanofibers, especially in the composite strength indicates that the used nanofibers have good mechanical properties and that there is an interaction between the PLA/PETG/HDPE and the CNF.

The baseline tensile strength of pure PLA was measured at 42.54 MPa. Introducing lignin into PLA significantly decreased tensile strength, with an average value of 25.89 MPa, representing a reduction of approximately 39%. This decrease can be attributed to the incompatibility of lignin with PLA, which disrupts the polymer matrix, creating weak points and reducing overall strength. It has been reported that a 25% decrease in tensile strength resulted from a 20 wt % addition of lignin. This result was attributed to a decrease in the effective load-bearing cross-section of PLA in the presence of lignin. TTT as a coupling agent alongside lignin resulted in a notable increase in tensile strength, reaching an average of 49.50 MPa, representing an increase of approximately 92%. TTT acts as a coupling agent, improving the adhesion between lignin and the PLA matrix, which enhances the interfacial bonding and, subsequently, the tensile strength. The combination of lignin, cellulose nanofibers, and TTT within the PLA matrix exhibited the highest tensile strength at 56.39 MPa, showcasing the synergistic enhancement achieved by adding multiple reinforcing agents. When tetraethoxysilane (TEOS) was introduced in the PLA composite with lignin and CNF, the highest tensile strength was recorded, with an average value of 57.16 MPa. TEOS likely played a role in forming a silica-based network within the composite, strengthening the material, and further improving the tensile strength. Others observed the resulting PLA/SiO₂ hybrids showed improved phase compatibility capable of creating covalent bonds between the organic and the inorganic phases. This strong bonding resulted in homogeneous microstructures with silica nanoparticles dispersed in the PLA matrix. Incorporating CNF with PLA, along with the cross-linking agents TTT and TEOS, enhances the tensile strength of the composite. This improvement can be attributed to the reinforcing effects of CNF, which bridges and strengthens the polymer matrix, ultimately enhancing load transfer and stress distribution within the material. PLA has been mixed with 1, 3, and 5 wt % of CNF and observed an increase in tensile strength and modulus of about 20% in all cases. Similar improvements have been reported for PLA-CNF with 5 wt % fiber content.

The baseline tensile strength of pure HDPE was established at 37.86 MPa. The introduction of lignin into HDPE decreased tensile strength, with an average of 28.04 MPa, representing a reduction of approximately 26%. In this case, lignin disrupts the HDPE matrix, creating weaknesses that result in decreased tensile strength. However, including TTT as a coupling agent alongside lignin increased tensile strength to 39.25 MPa, representing an increase of approximately 40%. TTT serves as a coupling agent, improving the adhesion between lignin and the HDPE matrix, strengthening the interfacial bonding, and improving tensile strength. The combination of lignin, CNF, and TTT within the HDPE matrix demonstrated the highest tensile strength at 50.84 MPa, highlighting the role of TTT in reinforcing interfacial interactions and representing an increase of approximately 81%. The enhancement in tensile strength can be attributed to the synergistic effects of CNF and TTT, where CNF strengthens the matrix, while TTT improves interfacial adhesion. Incorporating TEOS into HDPE with lignin led to an average tensile strength of 40.95 MPa, indicating an increase of approximately 7.4% compared to the composite without TEOS. TEOS likely formed a silica-based network, contributing to improved material strength, and the composite containing lignin, CNF, and TEOS which reached the highest tensile strength at 53.38 MPa, representing an increase of approximately 40% compared to the baseline. The addition of TEOS complemented the reinforcing effects of CNF and TTT, resulting in further improvement in tensile strength. It has been observed that, when the TEOS dosage in their HDPE hybrid material was linearly increased, the tensile strength linearly increased as well, finding an approximate 31% increase in their tensile strength with the addition of TEOS.

The baseline tensile strength of pure PETG was measured at 50.52 MPa. The introduction of lignin into PETG reduced tensile strength, averaging 39.96 MPa, representing a reduction of approximately 21%. This reduction is often associated with the incompatibility of lignin with PETG, weakening interfacial interactions, and reducing the strength. However, when TTT was added as a coupling agent alongside lignin, the tensile strength increased to 49.81 MPa, indicating an increase of approximately 25%. TTT improved interfacial bonding between lignin and PETG, enhancing tensile strength. The combination of lignin, cellulose nanofibers (CNF), and TTT within the PETG matrix resulted in the highest tensile strength at 54.29 MPa, demonstrating the synergistic effect achieved by incorporating multiple reinforcing agents and representing an increase of approximately 7.6%. CNF's reinforcing effect was crucial in this enhancement, while TTT improved adhesion, contributing to increased tensile strength. Additionally, incorporating TEOS into PETG with lignin led to an average tensile strength of 52.18 MPa, indicating an increase of approximately 30% compared to the composite without TEOS. TEOS likely strengthened the material further by forming a silica-based network. The composite containing lignin, CNF, and TEOS exhibited the highest tensile strength at 55.45 MPa, representing an increase of approximately 10.7% compared to the baseline. TEOS added to the synergistic effect of CNF and TTT, resulting in enhanced tensile strength.

Based on the characterizations, we proposed the cross linking diagram in PLA based composite. As depicted in FIG. 12, the incorporated lignin and CNF connect with the carbonyl groups in PLA through hydrogen bonds. Similarly, the TEOS links to the hydroxyl groups of lignin and CNF by both hydrogen and covalent bonds. Whereas, neither the Si—O nor the Si—O—C adsorption peaks were observed in FT-IR spectra. This might be because of the small number of Si—O or Si—O—C bonds trapped in the fragment of composite that were not detectable. The aliphatic fractions of CNF and lignin incorporation may enable to increase the tensile strength of composite. However, the aromatic fractions in lignin may decrease the tensile strength of PLA composite.

### CONCLUSION

In our study, we initially compared the controls, which were pure Polylactic Acid (PLA), Polyethylene Terephthalate Glycol (PETG), and High-Density Polyethylene (HDPE) to establish baseline tensile strengths. Among the controls, PLA exhibited a tensile strength of 42.54 MPa, HDPE had a tensile strength of 37.86 MPa, and PETG showed the highest tensile strength at 50.52 MPa. This initial comparison highlights the inherent differences in mechanical properties among these polymers, with PETG demonstrating superior tensile strength compared to PLA and HDPE. We then explored the impact of various additives on these polymer matrices. The introduction of lignin into the polymers initially led to decreased tensile strength, suggesting incompatibility and potential weakening of the matrix. However, adding cellulose nanofibers (CNF) alongside lignin positively affected tensile strength, indicating the potential for reinforcement through CNF addition. This observation suggests that CNF significantly enhances mechanical properties and could serve as a precursor for cross-linking. We incorporated Tetraethoxysilane (TEOS) and Tetramethyl Tetraphenyl Trisiloxane (TTT) into all three polymers to test the cross-linking hypothesis. The results supported our hypothesis, as adding TEOS and TTT significantly improved the tensile strength in all cases. This indicates that the cross-linking effect of TEOS and TTT successfully enhanced the mechanical properties of PLA, HDPE, and PETG.

To explore the potential replacement of PETG and HDPE with PLA-based composites, we compared the tensile strengths of PLA-Lignin and PLA-Lignin-CNF composites. The addition of lignin initially led to decreased tensile strength in PLA. However, the subsequent inclusion of CNF, known for its reinforcing properties, significantly improved tensile strength. This finding suggests that PLA-based composites, with the right combination of additives like CNF, can potentially replace PETG and HDPE while maintaining or enhancing tensile properties. This indicates a promising direction for sustainable and high-performance polymer composites in various applications.

It should be emphasized that the above-described embodiments and specific examples of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims

1. A method of extracting lignin from a plant biomass, comprising:
mixing a solvent with the plant biomass to form a mixture, wherein the solvent is a deep eutectic solvent comprising a heterocyclic compound;
heating the mixture for a time period sufficient to release lignin from the plant biomass; and
extracting lignin from the mixture after heating.

2. The method of claim 1, wherein the heterocyclic compound is a nitrogen heterocyclic compound.

3. The method of claim 2, wherein the nitrogen heterocyclic compound is selected from the group consisting of pyridine, pyrrole, and pyrazole.

4. The method of claim 1, wherein the solvent further comprises one or more of lactic acid, choline chloride, urea, and aniline.

5. The method of claim 1, wherein the plant biomass is a grain crop, wood, or grass.

6. The method of claim 1, wherein the mixture is heated at a temperature from 50° C. to 150° C.

7. The method of claim 1, wherein the time period ranges from 0.1 hour to 24 hours.

8. The method of claim 1, wherein an extraction yield of the lignin is at least 30%.

9. The method of claim 1, wherein a purity of the extracted lignin is at least 90%.

10. The method of claim 1, wherein the extracted lignin has a polydispersity index less than 1.9.

11. A lignin composition prepared by the method according to claim 1.

12. A method of preparing a composite material, comprising mixing lignin obtained according to the method of claim 1 with a polymer to form the composite material.

13. The method of claim 12, wherein the polymer is selected from the group consisting of polyacrylonitrile (PAN), polylactic acid (PLA), polyethylene terephthalate glycol (PETG), and high-density polyethylene (HDPE).

14. The method of claim 12, further comprising mixing a crosslinking agent with the lignin and polymer to form the composite material.

15. The method of claim 14, wherein the crosslinking agent is a siloxane compound.

16. The method of claim 12, further comprising mixing cellulose nanofibers with the lignin and polymer to form the composite material.

17. The method of claim 12, wherein the mixing is performed by extrusion, wet spinning, melting spinning, or casting.

18. The method of claim 12, wherein a ratio of lignin to polymer is from 1:9 to 9:1.

19. A method of extracting cellulose from a plant biomass, comprising:
mixing a solvent with the plant biomass to form a mixture, wherein the solvent is a deep eutectic solvent comprising a heterocyclic compound;
heating the mixture for a time period sufficient to release cellulose from the plant biomass; and
extracting cellulose from the mixture after heating.
